(19) United States
(12) Patent Application Publication
(10) Pub. No.: US 2004/0173630 A1
(43) Pub. Date: Sep. 9, 2004

(54) Desiccant dispenser and method of using the same

(76) Inventor: David Karl Stroup, El Cajon, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/763,157

(22) Filed: Jan. 22, 2004

Related U.S. Application Data
(60) Provisional application No. 60/442,285, filed on Jan. 23, 2003.

(51) Int. Cl. G07F 11/72

(52) U.S. Cl. 221/30

(57) ABSTRACT

A method of dispensing a desiccant packet to a target includes providing a strip of desiccant packets separated by packet webbing; providing a desiccant dispenser including a dual tractor belt drive system for advancing the strip of desiccant packets through the desiccant dispenser, a clamp assembly for clamping the strip of desiccant packets prior to cutting, a cutter blade assembly for cutting a desiccant packet from the strip of desiccant packets, the cutter blade assembly including a rotary blade with a blade portion having opposite angled cutting faces; cutting a desiccant packet from the strip of desiccant packets with the opposite angled cutting faces of the rotary blade of the cutter blade assembly without shearing the strip; and dispensing the desiccant packet on the target.

### CROSS-REFERENCE TO RELATED APPLICATION

This application claims the benefit under 35 U.S.C. 119(e) of prior provisional application 60/442,285, filed Jan. 23, 2003.

### FIELD OF THE INVENTION

The present invention is in the field of desiccant dispensers for automatically dispensing desiccant packets.

### BACKGROUND OF THE INVENTION

Desiccants are vital for maintaining the integrity and effectiveness of a wide range of pharmaceutical, nutritional, and in vitro diagnostic (IVD) products. To meet demand for specialized applications, desiccant manufacturers have devised a variety of formats—canisters, packets, tablets, capsules, filled stoppers, and more—to hold the silica gel, montmorillonite clay, or molecular sieve desiccant. The workhorses accounting for the greatest share of this market, however, are desiccant canisters and continuous-strip packets for high-speed automated dispensing.

Desiccant suppliers and equipment manufacturers hit upon the idea of manufacturing continuous spools of fanfolded strips of desiccant packets to be dispensed from an automated desiccant cutter/dispenser.

A problem with automated desiccant dispensers is that they do not necessarily dispense packets efficiently and reliably. Packets, instead of the webbing between packets, are accidentally sliced, contaminating the entire packaging line with spewed desiccant. This problem and others are addressed by the desiccant dispenser and method of use of the present invention.

### SUMMARY OF THE INVENTION

The desiccant dispenser of the present invention automatically dispenses packets efficiently and reliably, without slicing desiccant packets in the middle. With the desiccant dispenser of the present invention, prepackaged desiccant material on a spool is continuously fed from the spool to the desiccant dispenser. Two timing belts of a desiccant feed mechanism pulls the desiccant material to a placement sensor. The desiccant is cut by a rotary blade assembly and the cut desiccant is directed to the product via a gravity feed chute. The triggering of the cycle is accomplished via a photoelectric sensor that senses the presence of the product for optimal placement of the cut desiccant on the product.

Another aspect of the invention involves a method of dispensing a desiccant packet to a target. The method includes providing a strip of desiccant packets separated by packet webbing; providing a desiccant dispenser including a dual tractor belt drive system for advancing the strip of desiccant packets through the desiccant dispenser, a clamp assembly for clamping the strip of desiccant packets prior to cutting, a cutter blade assembly for cutting a desiccant packet from the strip of desiccant packets, and a position sensor for determining if the clamp assembly clamped on a desiccant packet instead of the packet webbing between desiccant packets; determining with the position sensor if the clamp assembly clamped on a desiccant packet instead of the packet webbing between desiccant packets; cutting a desiccant packet from the strip of desiccant packets with the cutter blade assembly and dispensing the desiccant packet on the target by cutting the packet webbing above a desiccant packet if it is determined that the clamp assembly is not clamped on a desiccant packet; and preventing the cutter blade assembly from cutting the strip of desiccant packets if it is determined that the clamp assembly is clamped on a desiccant packet.

Another aspect of the invention involves a method of dispensing a desiccant packet to a target. The method includes the steps of providing a strip of desiccant packets separated by packet webbing; providing a desiccant dispenser including a dual tractor belt drive system for advancing the strip of desiccant packets through the desiccant dispenser, the dual tractor belt drive system including a left roller assembly and a left tractor belt driven by the left roller assembly and a right roller assembly and a right tractor belt driven by the right roller assembly, a belt roller positioning mechanism for moving both roller assemblies and tractor belts between an open and a closed position, a clamp assembly for clamping the strip of desiccant packets prior to cutting, and a cutter blade assembly for cutting a desiccant packet from the strip of desiccant packets; moving both roller assemblies and tractor belts to an open position using the belt roller positioning mechanism and inserting the strip of desiccant packets between the tractor belts; moving both roller assemblies and tractor belts to a closed position using the belt roller positioning mechanism to maintain the strip of desiccant packets between the tractor belts; and cutting a desiccant packet from the strip of desiccant packets with the cutter blade assembly and dispensing the desiccant packet on the target by cutting the packet webbing above a desiccant packet.

A further aspect of the invention involves a method of dispensing a desiccant packet to a target. The method includes the steps of providing a strip of desiccant packets separated by packet webbing; providing a desiccant dispenser including a dual tractor belt drive system for advancing the strip of desiccant packets through the desiccant dispenser, a clamp assembly for clamping the strip of desiccant packets prior to cutting, a cutter blade assembly for cutting a desiccant packet from the strip of desiccant packets, the cutter blade assembly including a rotary blade with a blade portion having opposite angled cutting faces; cutting a desiccant packet from the strip of desiccant packets with the opposite angled cutting faces of the rotary blade of the cutter blade assembly without shearing the strip; and dispensing the desiccant packet on the target.

Further objects and advantages will be apparent to those skilled in the art after a review of the drawings and the detailed description of the preferred embodiments set forth below.

### BRIEF DESCRIPTION OF THE DRAWINGS

FIGS. 1A, 1B, and 1C are front-elevational, right side-elevational, and perspective views, respectively, of an embodiment of a desiccant dispenser and a supporting frame assembly of the present invention.

FIG. 2 is a front-elevational view of the desiccant dispenser illustrated in FIGS. 1A-1C with a front cover of the desiccant dispenser removed.

FIG. 3 is a right side-elevational view of the desiccant dispenser illustrated in FIG. 2 with portions of the desiccant dispenser housing removed.

FIG. 4 is a rear-elevational view of the desiccant dispenser illustrated in FIG. 3.

FIG. 5 is a top plan view of the desiccant dispenser illustrated in FIG. 3.

FIG. 6 is an exploded perspective view of the desiccant dispenser illustrated in FIGS. 1-5.

FIG. 7 is a partially exploded perspective view of an embodiment of a cutter blade assembly of the desiccant dispenser illustrated in FIGS. 1-5.

FIG. 8 is a partial cross-sectional view of an embodiment of a rotary cutter blade of the cutter blade assembly illustrated in FIG. 7.

### DETAILED DESCRIPTION OF PREFERRED EMBODIMENTS

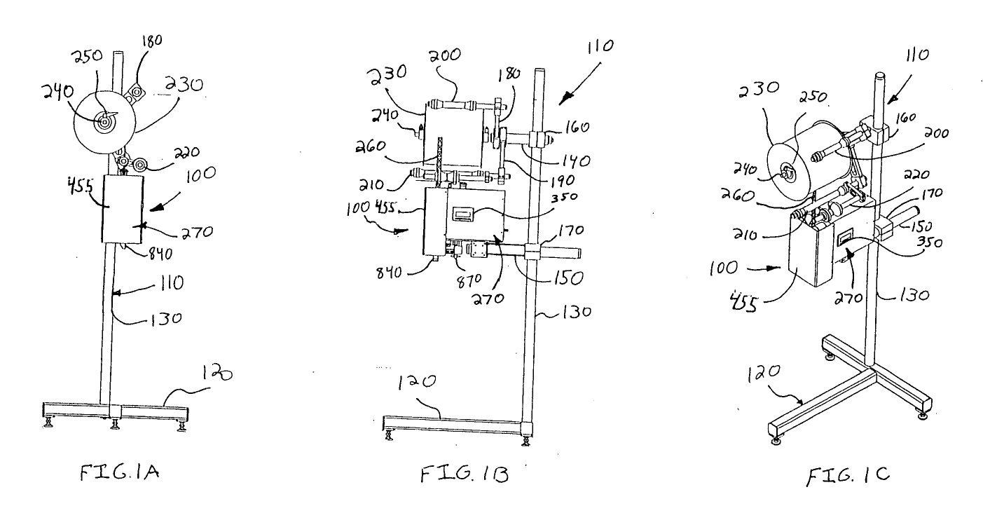

With reference to FIGS. 1A-1C, an embodiment of a desiccant dispenser 100 and supporting frame assembly 110 of the present invention will be described. Although the dispenser 100 will be described as a cutting and dispensing desiccant packets, it should be noted that the dispenser 100 may be used to cut and dispense other items that come in strips or rolls. The supporting frame assembly 110 will first be described before describing the desiccant dispenser 100.

The supporting frame assembly 110 is an adjustable T-stand including a T-shaped base 120 and a vertical support 130. An upper arm 140 and a lower arm 150 extend laterally from the vertical support 130 and are clamped to the vertical support 130 via collars 160, 170. Extending off of the laterally extending upper arm 140 are an upper-angled arm 180 and a lower-angled arm 190. An upper roller 200 extends laterally off of the upper-angled arm 180. A first lower roller 210 and a second lower roller 220 extend laterally off of the lower-angled arm 190. A spool 230 of prepackaged desiccant material is rotatably coupled to a desiccant roll shaft 240 of the upper arm 140. A removable desiccant roll tensioning adjustment screw and collar 250 may be used to maintain the spool 230 in position on the desiccant roll shaft 240 and to control the desiccant unwind tension force on the desiccant roll shaft 240. A strip 260 of desiccant material from the spool 230 may be threaded under, around, or over the first lower roller 210, the upper roller 200, and the second lower roller 220, and into the desiccant dispenser 100. An example of a strip 260/spool 230 of desiccant material that may be used with the embodiment of the desiccant dispenser 100 and the supporting frame assembly 110 of the present invention is sold under the trademark Continu-Strip by Sud-Chemie of Germany.

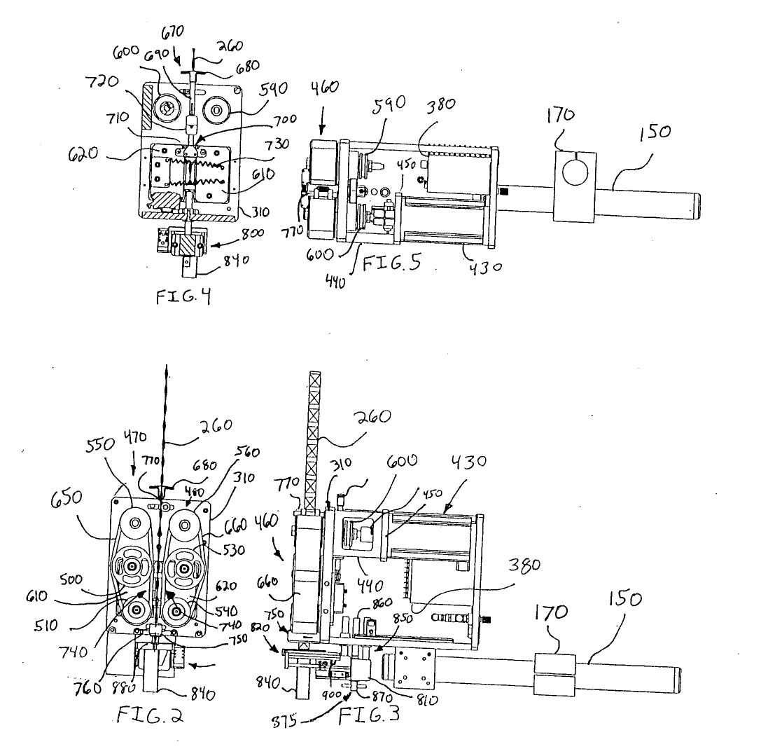

With reference additionally to FIGS. 2-6, the desiccant dispenser 100 will now be described in more detail. The desiccant dispenser 100 includes a housing 270 comprised of the following four members (FIG. 6): a top wall and right side wall member 280, a rear wall and bottom wall member 290, a left side wall member 300, and a front wall member 310.

The top wall and right side wall member 280 includes a top wall 320 that carries an emergency stop knob 330 and includes a cut-out 335. The emergency stop knob 330 may be used to shut down the desiccant dispenser 100 in the event of an emergency.

A side wall 340 of the member 280 carries an operator interface touch-screen display 350. The operator interface touch-screen display 350 includes push-button key control. Some of the buttons on the operator interface touch-screen display 350 include, but not by way of limitation, a manual cut and advance button and a manual stop cut and advance button. The manual cut and advance button may be pressed to manually advance and cut a single desiccant packet from the strip 260 of desiccant material. The manual stop cut and advance button may be pressed to stop the manual advance and cut if pressed immediately after pressing the manual cut and advance button.

The rear wall and bottom wall member 290 includes a rear wall 360 with an inner surface 370 that an electronic controller module 380 is attached to, and a bottom wall 375.

The front wall member 310 includes a pair of upper circular holes 390, an upper horizontal shaft 400, and a lower horizontal shaft 420. In an assembled condition, a combination servo motor and drive 430 extends from the rear wall 360, adjacent the electronic controller module 380, to the front wall member 310. The combination servo motor and drive 430 (and other electrical elements of the desiccant dispenser 100) require 120 Vac, 10 Amp power. A power switch (not shown) on the back of the rear wall 360 may be used to turn the desiccant dispenser 100 on or off. A square window frame 440 extends forwardly from a flange 450 of the combination servo motor and drive 430. A removable front safety cover 455 is detachably connected to the front wall member 310 of the housing 270. A front cover safety switch (not shown) may be located where the lower-right corner of the front cover 455 and lower-right corner of the housing 270 join. The front cover safety switch is used to detect whether the front cover 455 is properly connected to the housing 270, and will prevent the desiccant dispenser 100 from operating if the front cover 455 is not properly installed.

A dual tractor belt drive system 460 is mounted to the front wall member 310 of the housing 270. The dual tractor belt drive system 460 includes generally parallel left roller assembly 470 and right roller assembly 480. The left roller assembly 470 includes an upper drive roller 490, a central roller 500, and a bottom roller 510. Similarly, the right roller assembly 480 includes an upper drive roller 520, a central roller 530, and a bottom roller 540. The upper drive rollers 490, 520 include roller members 550, 560 that are connected by shafts 570, 580 to pulleys 590, 600. The upper drive rollers 290, 520 are rotatably mounted to the front wall member 310 at the upper circular holes 390. The central roller 500 and the bottom roller 510 of the left roller assembly 470 are rotatably mounted to a laterally slidable left plate 610. Similarly, the central roller 530 and the bottom roller 540 of the right roller assembly 480 are rotatably mounted to a laterally slidable right plate 620. Upper horizontal bores 630 and lower horizontal bores 640 of the laterally slidable plates 610, 620 receive the upper horizontal shaft 400 and the lower horizontal shaft 420, respectively, for slidably mounting the laterally slidable plates 610, 620 to the front wall member 310.

Left servo-driven tractor belt 650 and right servo-driven tractor belt 660 are disposed over the left roller assembly 470 and the right roller assembly 480.

The combination servo motor and drive 430 is operatively coupled to the pulleys 590, 600 (e.g., through one or more belts) for driving the pulleys 590, 600, which in turn drive the roller members 550, 560 to drive the servo-driven tractor belts 650, 660.

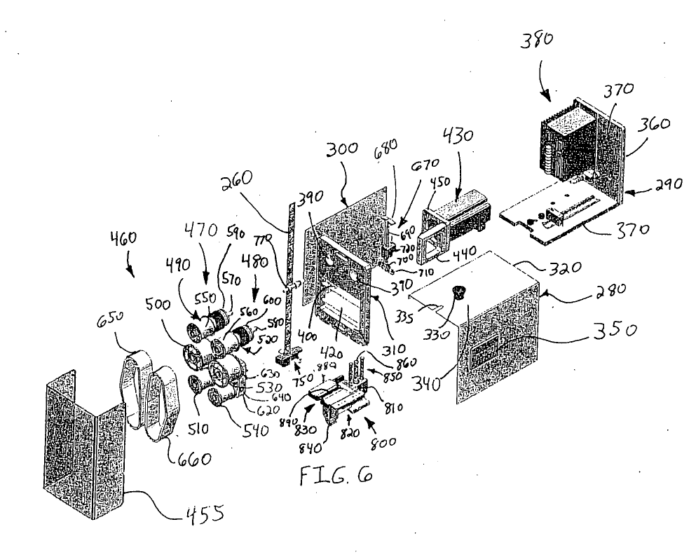

With reference specifically to FIG. 4, an embodiment of a belt roller positioning mechanism 670 will now be described. The belt roller positioning mechanism 670 may be used to open and close the servo-driven tractor belts 650, 660 to allow for feeding the strip of desiccant material through the desiccant dispenser 100. The belt roller positioning mechanism 670 includes a handle 680 that extends upward from the top wall 320 through the cut-out 335. A shaft 690 connects the handle 680 to a junction member 700. The junction member 700 is pivotally connected to opposite pivot arms 710. The pivot arms 710 couple the cam member 700 to the plates 610, 620. The shaft 690 is slidably disposed within an alignment sleeve 720, which is mounted to the front wall member 310. Springs 730 connect the plates 610, 620 and bias the plates laterally inward, towards each other.

To separate lower portions 740 of the belts 650, 660, which are the portions of the belts 650, 660 extending between the central rollers 500, 530 and the bottom rollers 510, 540, while maintaining the belts 650, 660 parallel with each other, the handle 680 is pressed down. Pressing the handle 680 down, causes the junction member 700 to move down and the pivot arms 710 to pivot outward to the substantially horizontal configuration shown in FIG. 4. Pivoting of the pivot arms 710 outward causes the plates 610, 620 to slide laterally away from each other, along the horizontal shafts 400, 420. Because the central roller 500 and the bottom roller 510 are fixed to the left plate 610 and the central roller 530 and the bottom roller 540 are fixed to the right plate 620, slidable separation of the plates 610, 620 along the horizontal shafts 400, 420 causes the lower portions 740 of the belts 650, 660 to separate and remain parallel to each other. When the handle 680 is pressed down completely, as shown in FIG. 4, the pivot arms 710 are disposed in a locked configuration that prevents the springs 730 from urging the plates 610, 620 together.

To bring the plates 610, 620 and, hence, the lower portions 740 of the belts 650, 660 together, the handle 680 is pulled upward so that the pivot arms 710 are no longer disposed in the locked configuration. This allows the springs 730 to urge the plates 610, 620 and the lower portions 740 of the belts 650, 660 together.

The belt roller positioning mechanism 670 and method of use described above causes the lower portion of both servo-driven tractor belts 650, 660 to quickly and easily separate or come together in a parallel fashion, allowing the strip 260 of desiccant material to be quickly and easily removed, added, or changed in the desiccant dispenser 100.

With reference to FIGS. 2 and 6, a sensor guide 750 may be mounted to the lower front of the front wall member 310, beneath the dual tractor belt drive system 460. The sensor guide 750 has a generally rectangular block-like configuration and includes a generally rectangular hole that extends vertically through the sensor guide 750. The strip 260 of desiccant material 260 is threaded through the generally rectangular hole of the sensor guide 750. A cylindrical bore, which receives a fiber-optic desiccant sensor 760, extends horizontally through the sensor guide 750. The fiber-optic desiccant sensor 760 detects the proper cutting placement of the desiccant webbing between desiccant packets of the strip 260 of desiccant material, and triggers a desiccant cutting blade (to be described) to cut the packet from the strip 260.

With reference to FIGS. 2, 3, 5, and 6, an adjustable desiccant guide 770 is mounted to the central upper front of the front wall member 310, above the dual tractor belt drive system 460. The adjustable desiccant guide 770 is used to guide the strip 260 of desiccant material into the dual tractor belt drive system 460. The adjustable desiccant guide 770 may have an adjustable collar to adjust the width of the guide 770 to accommodate different width packets.

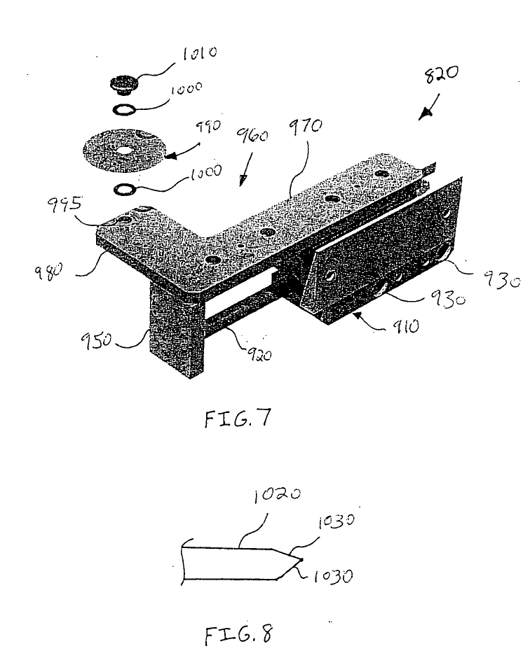

With reference to FIGS. 2-6, a combination cutter blade and clamp assembly 800 for clamping, cutting, and dispensing the desiccant packets of the strip 260 will now be described. The combination cutter blade and clamp assembly 800 includes a base 810 with a cutter blade assembly 820 (FIG. 7), a clamp assembly 830, and a gravity feed chute 840 mounted thereto. The combination cutter blade and clamp assembly 800 is mounted to the bottom wall 370 via shafts 850. A central shaft 860 is threadably connected to the bottom wall 370 for vertical adjustment of the base 810 relative to the dual tractor belt drive system 460. A cutting length adjustment handle 870 disposed at a bottom of the central shaft 860 is rotatable to adjust the height of the combination cutter blade and clamp assembly 800 for vertically adjusting cutting blade placement. Such adjustment may be necessary when changing to different sized desiccant packs. The cutting length adjustment handle 870 and central shaft 860 form a manual cutting length adjustment mechanism 875 for quickly and easily adjusting cutting blade placement.

The clamp assembly 830 includes opposite clamps 880 with clamp engaging surfaces 890 for clamping and holding the strip 260 of desiccant material in the desiccant webbing between desiccant packets, prior to cutting. Either or both of the clamps 880 may be movable for clamping the strip 260. An air cylinder or other pneumatic or hydraulic device may be used to move the clamp(s) 880. The desiccant dispenser 100 includes an air pressure regulator and an air pressure gauge. The air pressure should be regulated to 60 PSI+/−5 PSI. The air consumption requirements of the air cylinder (and the air cylinder 910 described below) are 10 scfm max at 75 psi min. When the opposite clamps 880 clamp together onto the desiccant webbing between desiccant packets, the clamps 880 are closed so that no substantial gap will exist between the clamp engaging surfaces 890. As used herein, no substantial gap means a gap no greater than the width of the desiccant webbing between desiccant packets. If the clamps 880 accidentally clamp onto a desiccant packet instead of the webbing, the clamps 880 will not close, the clamp engaging surfaces 890 will be separated by a distance equal to the thickness of the desiccant packet. A position sensor 900 (FIG. 3) determines whether the clamps 880 are closed. For example, the position sensor 900 may measure the distance between the clamp engaging surfaces 890 when the clamps 880 closed, which may be used to determine if the clamps 880 are open or closed, depending on whether the distance is greater than the thickness of the webbing between packets. If the position sensor 900 detects a gap distance indicative of the clamps 880 closing on the desiccant packet instead of the webbing, the cutter blade assembly 820 will be prevented from cutting the desiccant packet. Examples of devices that may be used as a position sensor 880 to recognize if the clamps 880 have closed on the desiccant packet include, but not by way of limitation, an inductive sensor and a proximity switch. A target photoelectric sensor (not shown) is preferably also used to detect a target to which the desiccant packet will be dispensed.

If the fiber-optic desiccant sensor 760, position sensor 900, and target photoelectric sensor all indicate a desiccant packet should be cut, the cutter blade assembly 820 will be activated to cut and dispense a desiccant packet from the strip 260 and the dual tractor belt drive system 460 will be activated to advance the strip 260 for the next cutting and dispensing.

With reference additionally to FIGS. 7 and 8, the cutter blade assembly 820 will be described in more detail. The cutter blade assembly 820 includes an air cylinder 910 with a reciprocating cylindrical shaft 920. Pneumatic lines (not shown) may be attached to the air cylinder 910 at ports 930, 940 for pneumatically driving the air cylinder 910. A distal end of the shaft 920 is connected to a generally rectangular block 950. The generally rectangular block 950 is connected to the underside of a L-shaped bracket 960. The L-shaped bracket 960 includes a narrow elongated extension 970 that is slidably mounted to a top of the air cylinder 910 and a short blade support 980. A rotary blade 990 is rotatably coupled to the blade support 980 through a threaded hole 995 via washers 1000 and fastener 1010. The rotary blade 990 is rotatably coupled to the blade support 980 so that the rotary blade 990 rotates no more than 30 degrees with each cut of the strip 260 of desiccant material.

With reference to FIG. 8, a cross-sectional view of a blade portion 1020 of the rotary blade 990 is shown. The blade portion 1020 includes opposite angled cutting faces 1030. The opposite angled cutting faces 1030 allow the rotary blade 990 to cut instead of shear the webbing between packets of desiccant material.

The manual cutting length adjustment mechanism 875 allows cutting blade placement to be quickly and easily adjusted, which is especially convenient when desiccant packets of varied lengths are used with the desiccant dispenser 100. The adjustable desiccant guide 770 and the adjustable collar allow different width packets to be accommodated.

A method of using the desiccant dispenser 100 will now be described. The desiccant dispenser 100 is first positioned to the location where the desiccant packets will be dispensed. Next, the gravity feed chute 840 is positioned above the location where the desiccant packets will be dispensed. The placement of the target photoelectric sensor is then determined and the target photoelectric sensor is mounted.

The spool 230 of desiccant material is installed on the desiccant roll shaft 240 and the strip 260 of desiccant material is fed over and around the rollers 200, 210, 220, over the adjustable desiccant guide 770, through the dual tractor belt drive system 460, through the sensor guide 750, and between the clamp engaging surfaces 890 of the combination cutting blade and clamp assembly 800.

An adjustable collar on the adjustable desiccant guide 770 may be adjusted to accommodate the width of the strip 260.

Before feeding the strip 260 through the dual tractor belt drive system 460, the left roller assembly 470 and belt 650 and the right roller assembly 480 and belt 660 are separated. To separate lower portions 740 of the belts 650, 660, the handle 680 is pressed down, causing the junction member 700 to move down and the pivot arms 710 to pivot outward to the substantially horizontal configuration shown in FIG. 4. Pivoting of the pivot arms 710 outward causes the plates 610, 620 and the lower portions 740 of the belts 650, 660 to slide laterally away from each other, along the horizontal shafts 400, 420. Pressing the handle 680 down completely, as shown in FIG. 4, causes the pivot arms 710 to be locked, preventing the springs 730 from urging the plates 610, 620 together.

Once the strip 260 is fed between the belts 650, 660, the left roller assembly 470 and belt 650 and the right roller assembly 480 and belt 660 are closed onto the strip 260. This is done by pulling the handle 680 upward so that the pivot arms 710 are no longer disposed in the locked configuration. This allows the springs 730 to urge the plates 610, 620 and the lower portions 740 of the belts 650, 660 together onto the strip 260.

Cutting blade position is determined and vertically adjusted if necessary using the manual cutting length adjustment mechanism 875. The cutting length adjustment handle 870 is rotated, causing the height of the combination cutter blade and clamp assembly 800 to be vertically adjusted until the desired vertical cutting blade placement is achieved.

A power cord and plug of the desiccant dispenser 100 is connected to a 120 Vac outlet. An air pressure hose is connected from the air supply to the desiccant dispenser 100. As an additional safety measure, an air pressure regulator should be installed between the air supply and the desiccant dispenser 100. The front safety cover 455 is then installed.

The desiccant dispenser 100 is turned on using the power switch. Air pressure is supplied to the desiccant dispenser 100 by opening an air supply valve or regulator. The pressure should be set to 60 PSI+/−5 PSI.

During operation, the desiccant packets of the strip 260 are constantly fed from the spool 230 to the desiccant dispenser 100. The dual tractor belt drive system 460 advances the strip 260 to the combination cutting blade and clamp assembly 800. The clamps 880 of the clamp assembly 830 are closed on the strip 260. Cutting of the strip 260 with the cutter blade assembly 820 is triggered upon the occurrence of at least the following three conditions: 1) the photoelectric sensor detects the presence of a target moving through a process, 2) the fiber-optic desiccant sensor 760 detects webbing between desiccant packets of the strip, and 3) the position sensor 900 determines that the clamps 880 are completely closed and not clamping on a desiccant packet. The cutter blade assembly 820 cuts a desiccant packet from the strip 260 by cutting the webbing above the packet. The air cylinder 910 causes the rotary blade 990 to reciprocate back and forth, cutting a packet from the strip 260 with movement in each direction. It should be noted, with certain targets, it may be desirable to dispense multiple packets for each target. The operator interface tough-screen display 350 and electronic controller module 380 are used to control the indexing of the packets so that one or more packets are dispensed per target. Once a packet is cut from the strip 260, the packet falls through the gravity feed chute 840 and lands on the target. The strip 260 is advanced by the dual tractor belt drive system 460 and ready for the next triggering event.

To shut down the desiccant dispenser 100, the power switch is turned off. The air pressure valve is closed to shut off air pressure to the desiccant dispenser 100. The air pressure hose is disconnected from the desiccant dispenser 100, the electrical cord and plug is removed from the power outlet, and the spool 230 of desiccant material is removed from the desiccant roll shaft 240.

It will be readily apparent to those skilled in the art that still further changes and modifications in the actual concepts described herein can readily be made without departing from the spirit and scope of the invention as defined by the following claims.

What is claimed is:

1. A method of dispensing a desiccant packet to a target, comprising the steps of:
providing a strip of desiccant packets separated by packet webbing;
providing a desiccant dispenser including a dual tractor belt drive system for advancing the strip of desiccant packets through the desiccant dispenser, a clamp assembly for clamping the strip of desiccant packets prior to cutting, a cutter blade assembly for cutting a desiccant packet from the strip of desiccant packets, and a position sensor for determining if the clamp assembly clamped on a desiccant packet instead of the packet webbing between desiccant packets;
determining with the position sensor if the clamp assembly clamped on a desiccant packet instead of the packet webbing between desiccant packets;
cutting a desiccant packet from the strip of desiccant packets with the cutter blade assembly and dispensing the desiccant packet on the target by cutting the packet webbing above a desiccant packet if it is determined that the clamp assembly is not clamped on a desiccant packet; and
preventing the cutter blade assembly from cutting the strip of desiccant packets if it is determined that the clamp assembly is clamped on a desiccant packet.

2. The method of claim 1, further including a fiber-optic desiccant sensor, and the method further including the steps of sensing with the fiber-optic sensor the webbing between desiccant packets, and preventing the cutter blade assembly from cutting the strip of desiccant packets if the webbing between desiccant packets is not sensed.

3. The method of claim 1, further including a photoelectric sensor, and the method further including the steps of determining with the photoelectric sensor whether the target is below the desiccant dispenser, and preventing the cutter blade assembly from cutting the strip of desiccant packets if it is determined that target is not below the desiccant dispenser.

4. The method of claim 1, wherein the cutter blade assembly includes a rotary blade with a blade portion having opposite angled cutting faces.

5. The method of claim 4, wherein the rotary blade rotates less than 30 degrees during cutting.

6. The method of claim 1, further including a manual cutting length adjustment mechanism for manually adjusting the cutting position of the cutter blade assembly, and the method further including manually adjusting the cutting position of the cutter blade assembly with the manual cutting length adjustment mechanism.

7. The method of claim 1, wherein the dual tractor belt drive system includes a left roller assembly and a left tractor belt driven by the left roller assembly and a right roller assembly and a right tractor belt driven by the right roller assembly, the desiccant dispenser further including a belt roller positioning mechanism for moving both roller assemblies and tractor belts between an open and a closed position, and the method further including moving both roller assemblies and tractor belts between an open and a closed position using the belt roller positioning mechanism.

8. The method of claim 7, wherein left tractor belt and right tractor belt include parallel lower portions, and the belt roller positioning mechanism moves both roller assemblies and tractor belts between an open and a closed position while maintaining the lower portions of the tractor belts parallel to each other.

9. The method of claim 8, wherein the dual tractor belt drive system includes one or more springs that cause the lower portions of the tractor belts to be urged towards each other.

10. A method of dispensing a desiccant packet to a target, comprising the steps of:
providing a strip of desiccant packets separated by packet webbing;
providing a desiccant dispenser including a dual tractor belt drive system for advancing the strip of desiccant packets through the desiccant dispenser, the dual tractor belt drive system including a left roller assembly and a left tractor belt driven by the left roller assembly and a right roller assembly and a right tractor belt driven by the right roller assembly, a belt roller positioning mechanism for moving both roller assemblies and tractor belts between an open and a closed position, a clamp assembly for clamping the strip of desiccant packets prior to cutting, and a cutter blade assembly for cutting a desiccant packet from the strip of desiccant packets;
moving both roller assemblies and tractor belts to an open position using the belt roller positioning mechanism and inserting the strip of desiccant packets between the tractor belts;
moving both roller assemblies and tractor belts to a closed position using the belt roller positioning mechanism to maintain the strip of desiccant packets between the tractor belts; and
cutting a desiccant packet from the strip of desiccant packets with the cutter blade assembly and dispensing the desiccant packet on the target by cutting the packet webbing above a desiccant packet.

11. The method of claim 10, wherein the left tractor belt and the right tractor belt include parallel lower portions, and the belt roller positioning mechanism moves both roller assemblies and tractor belts between an open and a closed position while maintaining the lower portions of the tractor belts parallel to each other.

12. The method of claim 11, wherein the dual tractor belt drive system includes one or more springs that cause the lower portions of the tractor belts to be urged towards each other.

13. The method of claim 10, further including a manual cutting length adjustment mechanism for manually adjusting the cutting position of the cutter blade assembly, and the method further including manually adjusting the cutting position of the cutter blade assembly with the manual cutting length adjustment mechanism.

14. A method of dispensing a desiccant packet to a target, comprising the steps of:
providing a strip of desiccant packets separated by packet webbing;
providing a desiccant dispenser including a dual tractor belt drive system for advancing the strip of desiccant packets through the desiccant dispenser, a clamp assembly for clamping the strip of desiccant packets prior to cutting, a cutter blade assembly for cutting a desiccant packet from the strip of desiccant packets, the cutter blade assembly including a rotary blade with a blade portion having opposite angled cutting faces;
cutting a desiccant packet from the strip of desiccant packets with the opposite angled cutting faces of the rotary blade of the cutter blade assembly without shearing the strip; and
dispensing the desiccant packet on the target.

15. The method of claim 14, wherein the rotary blade rotates less than 30 degrees during cutting.

16. The method of claim 14, further including a manual cutting length adjustment mechanism for manually adjusting the cutting position of the cutter blade assembly, and the method further including manually adjusting the cutting position of the cutter blade assembly with the manual cutting length adjustment mechanism.
